(19) United States
(12) Patent Application Publication
(10) Pub. No.: US 2025/0292767 A1
(43) Pub. Date: Sep. 18, 2025

(54) DERIVING OBJECT EMPHASIS WITHIN A VIRTUAL ENVIRONMENT

(71) Applicant: INTERNATIONAL BUSINESS MACHINES CORPORATION, Armonk, NY (US)

(72) Inventors: Scott E. Schneider, Rolesville, NC (US); Sophie Batchelder, Cambridge, MA (US); Steven Lee Fisher-Stawinski, Buffalo Grove, IL (US)

(21) Appl. No.: 18/604,718

(22) Filed: Mar. 14, 2024

(51) Int. Cl. G10L 15/18; G06T 11/00; G10L 15/22

(52) U.S. Cl. CPC G10L 15/1815; G06T 11/00; G10L 15/22

(57) ABSTRACT

A computer implemented method may include: analyzing, via natural language processing, a conversational input between a plurality of users to identify a description of an element; applying, via a machine learning model, a matching procedure between the conversational input and a virtual environment to identify the element matching the description of the element; generating an emphasis representation in a programmatic model of the virtual environment based on the description of the element; and applying an emphasis effect to the element within the virtual environment corresponding to the emphasis representation.

### BACKGROUND

Aspects of the present invention relate generally to virtual environments, e.g., a metaverse, a video game, a virtual meeting, etc., may include a plurality of visual elements, objects, information, or audio data, etc., and more particularly, to communication and/or interactions within virtual environments.

### SUMMARY

In a first aspect of the invention, there is a computer-implemented method including: analyzing, via natural language processing, a conversational input between a plurality of users to identify a description of an element; applying, via a machine learning model, a matching procedure between the conversational input and a virtual environment to identify the element matching the description of the element; generating an emphasis representation in a programmatic model of the virtual environment based on the description of the element; and applying an emphasis effect to the element within the virtual environment corresponding to the emphasis representation.

In another aspect of the invention, there is a computer program product including one or more computer readable storage media having program instructions collectively stored on the one or more computer readable storage media. The program instructions are executable to: analyze, via natural language processing, a conversational input between a plurality of users to identify a description of an element; apply, via a machine learning model, a matching procedure between the conversational input and a virtual environment to identify the element matching the description of the element; generate an emphasis representation in a programmatic model of the virtual environment based on the description of the element; and apply an emphasis effect to the element within the virtual environment corresponding to the emphasis representation.

In another aspect of the invention, there is a system including a processor set, one or more computer readable storage media, and program instructions collectively stored on the one or more computer readable storage media. The program instructions are executable to: a processor set, one or more computer readable storage media, and program instructions collectively stored on the one or more computer readable storage media, the program instructions executable to: analyze, via natural language processing, a conversational input between a plurality of users to identify a description of an element; apply, via a machine learning model, a matching procedure comprising generative artificial intelligence for performing the matching procedure between the conversational input and a virtual environment to identify the element matching the description of the element; generate an emphasis representation in a programmatic model of the virtual environment based on the description of the element; and apply an emphasis effect to the element within the virtual environment corresponding to the emphasis representation.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of an exemplary environment in accordance with aspects of the present invention.

FIG. 4 shows a flowchart of an exemplary use case in accordance with aspects of the present invention.

FIG. 5 shows a flowchart of an exemplary use case in accordance with aspects of the present invention.

FIG. 6 shows a flowchart of an exemplary method in accordance with aspects of the present invention.

### DETAILED DESCRIPTION

Aspects of the present invention relate generally to object emphasis and, more particularly, to audible or visual emphasis within a virtual environment to draw attention to a particular object, i.e., an element. A virtual environment may include a metaverse, a video game, a virtual meeting, or any individual or shared software application in which users may participate through inputs such as text, audio, video, device inputs, e.g., computer mouse and keyboard inputs, and outputs such as media, dynamically rendered interactions, e.g., in a video game, etc. Virtual environments may also include virtual world environments, such as a video game or virtual meeting. Virtual environments may include virtual reality environments, such as a metaverse, i.e., a shared, persistent, augmented reality or a virtual reality environment that may include social media, entertainment, user-to-user interaction, shopping aspects, etc.

According to aspects of the invention, a system, computer-implemented method, and a computer program product may include identifying and emphasizing existing objects or information in a virtual environment based on a natural language processing (NLP) of inputs and conversations between users participating in the virtual environment. In embodiments, a computer-implemented method, a system, and a computer program product may analyze multi-modal conversational input between users, e.g., in a chat window or verbal communication, in real-time.

The computer-implemented method, the system, and the computer program product may identify elements of the environment that correlate to the natural language within the conversation between the users using artificial intelligence (AI) and machine learning (ML). AI or ML may include generative artificial intelligence or a pre-trained machine learning model operating on natural language conversational input to generate emphasizable representations in a programmatic model. A pre-trained machine learning model may include a generative adversarial network, variational autoencoder, autoregressive model, etc. The computer-implemented method, the system, and the computer program product may emphasize or highlight the identified object to stand out from other objects within the environment. In this manner, implementations of the invention improve the ability to identify and render an emphasis for an element within a virtual environment through AI, and ML techniques, including generative AI.

Interactions between users within a virtual environment may include a user discussing a topic or object being displayed or rendered that may not be easily visible to other users. For example, a screen may be crowded with information and objects. In other examples, the discussion of the user is potentially ambiguous to other users as to what object or objects another user is referencing. Aspects of the present invention improve the identification of objects or information in a virtual environment by identifying, via machine learning (ML), AI, and NLP, topics within a conversation, identifying matching objects or information within the virtual environment and matching the topics to the objects or information. In embodiments, within the virtual environment, objects or information matched to topics may be emphasized, such as highlighting the object, providing audio output, or other visual or audible cues to draw attention to the object or information. In this manner, embodiments are configured to identify and emphasize objects or information to reduce miscommunication within virtual environments. Additionally, embodiments are configured to provide visual emphasis or audible emphasis in a virtual environment, such as rendering emphasis effect e.g., highlighting of digital objects, or rendering an emphasizing effect of digital information displayed by a computing device, which cannot be performed mentally or with a pen and paper and necessarily requires computer implementation.

Implementations of the invention are necessarily rooted in computer technology. For example, the steps of analyzing, via a natural language processing module, a conversational input between a plurality of users to identify a description of an element; applying, via the machine learning model, a matching procedure between the conversational input and a virtual environment to identify the element within the virtual environment matching the description of the element; generating an emphasis representation in a programmatic model of the virtual environment based on the description of the element; and applying an emphasis effect corresponding to the emphasis representation of the element within the virtual environment are computer-based and cannot be performed in the human mind. Training and using a machine learning model, including using computer-implemented NLP are, by definition, performed by a computer and cannot practically be performed in the human mind (or with pen and paper) due to the complexity and massive amounts of calculations involved. Given this scale and complexity, it is simply not possible for the human mind, or for a person using pen and paper, to perform the number of calculations involved in training and/or using a machine learning model.

According to embodiments, a computer-implemented method for dynamically identifying and emphasizing existing objects in a virtual environment based on a natural language processing, the computer-implemented method may include: analyzing, by one or more natural language techniques, a multi-modal conversational input, e.g., written text and spoken word inputs, between a plurality of users in real-time; identifying a description of a portion of the virtual environment by applying a matching procedure between the multi-modal conversational input and the virtual environment, wherein the matching procedure includes at least one pre-trained machine learning model that operates on the multi-modal conversational input; generating one or more emphasizable representations in a programmatic model of the virtual environment based on the multi-modal conversational input; and applying an emphasizable effect to the emphasizable representations in the virtual environment.

According to embodiments, the computer-implemented method may further include identifying elements of the virtual environment that correlate to the multi-modal conversational input within the conversation between the users, wherein the multi-modal conversational input includes a natural language conversation. According to embodiments, the computer-implemented method may further include identifying an object in the virtual environment based on the matching procedure, wherein the identified object is emphasized or highlighted to stand out from other objects within the virtual environment.

According to embodiments, the computer-implemented method may include identifying parts not explicitly named but inferred from the natural language conversational input. According to embodiments, the computer-implemented method may include adjusting the emphasis effect applied to the identified parts based on the amount of time that has elapsed since the object was referenced in the conversation.

According to embodiments, the computer-implemented method may include determining a level of confidence that each emphasis representation is the part being referred to in the conversation, wherein the level of confidence is distinct from the emphasis effect. According to embodiments, the computer-implemented method may include the multi-model conversation input which further includes at least one of a text input and voice input, and wherein the virtual environment is an immersive virtual environment being at least one of a virtual world environment and a virtual reality environment.

According to embodiments, the computer-implemented method may include identifying objects not explicitly named but inferred from natural language conversational input. According to embodiments, the computer-implemented method may include adjusting an emphasis effect applied to identified objects based on the amount of time that has elapsed since the objects were referenced in conversational input.

According to embodiments, the computer-implemented method may include determining a level of confidence that each emphasizable representation is the object being referred to in the conversational input wherein the level of confidence is distinct from the emphasis effect. According to embodiments, the computer-implemented method may include multimodal conversational input that may include at least one of text input or voice input.

According to embodiments, the computer-implemented method may include an immersive virtual environment being at least one of a virtual world environment or a virtual reality environment. According to embodiments, the computer-implemented method may include A matching procedure based on user context.

According to embodiments, the computer-implemented method may include a matching procedure based on a user context. According to embodiments, the computer-implemented method may include a virtual environment that is a video game environment. According to embodiments, the computer-implemented method may include a selected group of users that are members of the same team in a multiplayer gaming environment or the same company in an enterprise collaboration environment. According to embodiments, the computer-implemented method may include an emphasis effect or a level of confidence that is displayed only to a selected group of users. According to embodiments, the computer-implemented method may include a selected group of users that are participating in a private conversation that is separate from the conversations of other users. According to embodiments, the computer-implemented method may include emphasis representations including at least one avatar controlled by a human user or an avatar controlled by a computer system. According to embodiments, the computer-implemented method may include an emphasis effect or a level of confidence that updates periodically or in substantially real-time as a conversation continues.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as derived emphasis code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

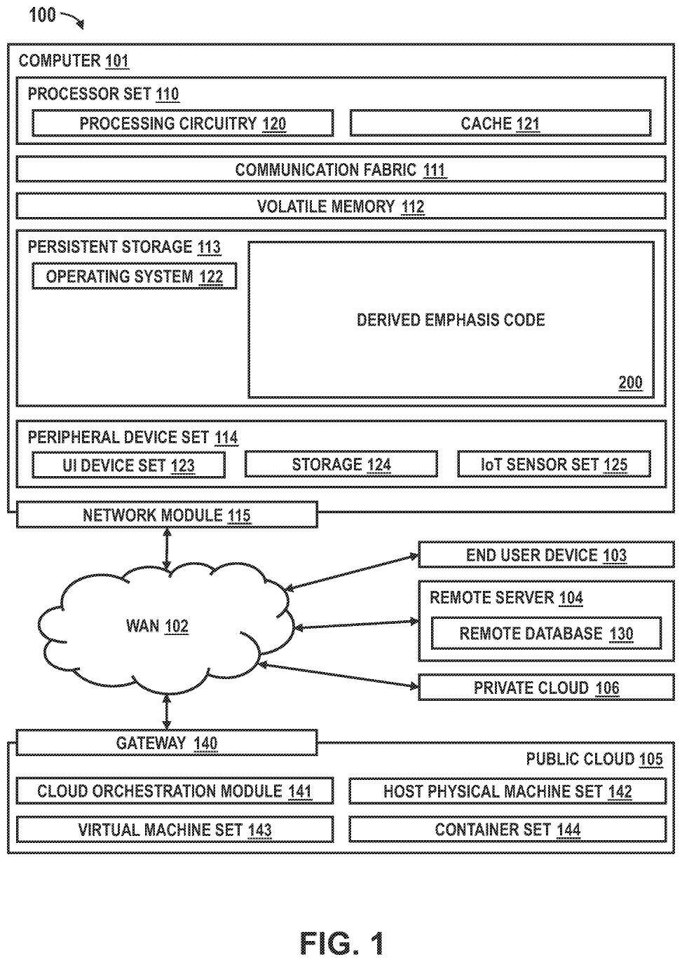

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

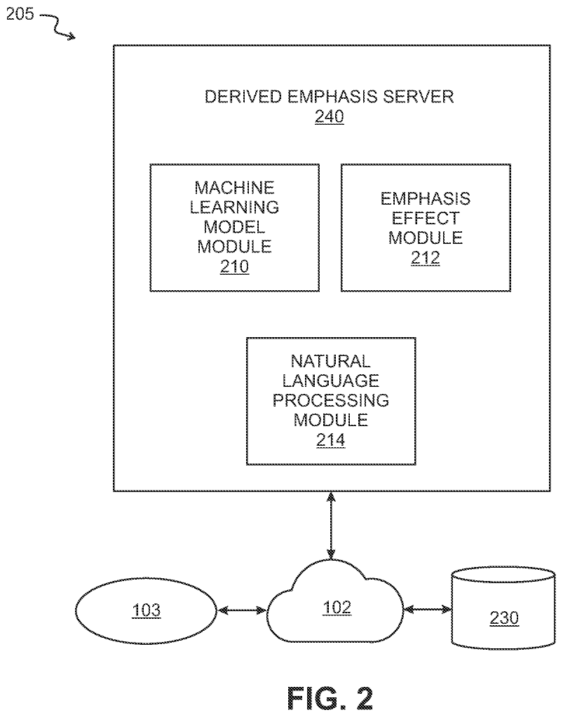

FIG. 2 shows a block diagram of an exemplary environment 205 in accordance with aspects of the invention. In embodiments, the environment 205 includes a derived emphasis server 240 corresponding to computer 101 of FIG. 1 and performing the inventive steps corresponding to block 200 of FIG. 1. In embodiments, the derived emphasis server 240 may be implemented in specific settings such as via an application programming interface (API) specific to a particular computer program. The derived emphasis server 240 includes or is in communication with a machine learning model module 210 configured to perform a matching procedure via generative AI, amongst other features. The derived emphasis server 240 includes or is in communication with a natural language processing module 214 configured to perform NLP of multi-modal input, amongst other features. The derived emphasis server 240 also includes an emphasis effect module 212. The derived emphasis server 240 may be configured to simultaneously communicate with a plurality of different EUDs 103, corresponding to EUD 103 of FIG. 1. Communication between the derived emphasis server 240 and EUDs 103 may include monitoring and analyzing conversational inputs received via an EUD 103 and applying an emphasis effect to an element within a virtual environment displayed on the EUD 103. The environment 205 includes at least one database 230 in communication with the derived emphasis server 240 over WAN 102 (i.e., corresponding to WAN 102 of FIG. 1). The database 230, which corresponds with remote server 104 or remote database 130 of FIG. 1, may store data relating to conversational inputs, virtual environments, elements and objects within virtual environments, emphasis representations, and emphasis effects.

In embodiments of FIG. 2, the derived emphasis server 240 of FIG. 2 includes the machine learning model module 210, emphasis effect module 212, and the natural language processing module 214 each of which may include modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The derived emphasis server 240 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

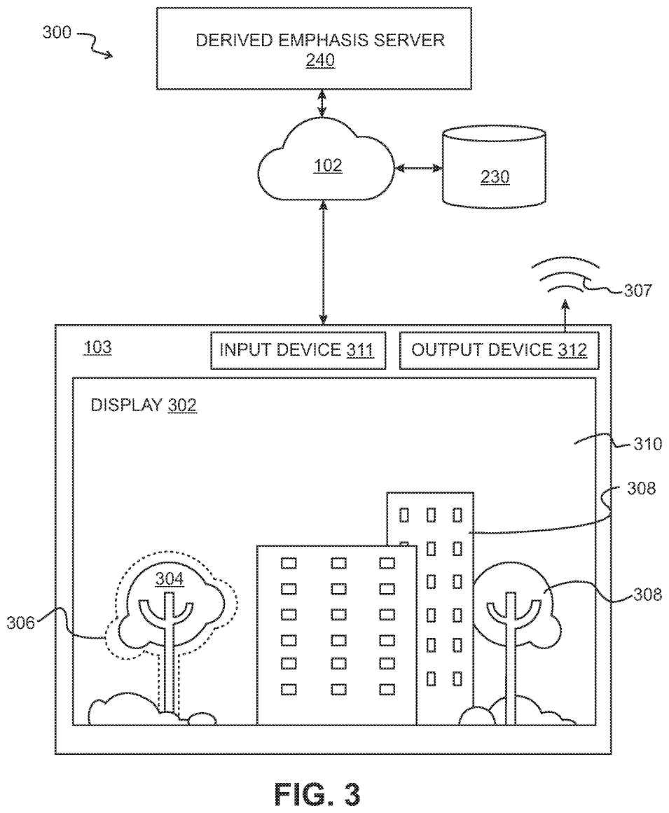

FIG. 3 shows a block diagram of an exemplary environment 300, corresponding to the exemplary environment 205 of FIG. 2, in accordance with aspects of the present invention. Steps of the method may be carried out in the environment of FIG. 2 and are described with reference to elements depicted in FIG. 2. In the exemplary environment 300, the system may include the derived emphasis server 240 of FIG. 2 in communication with EUD 103 of FIGS. 1 and 2 over WAN 102 of FIGS. 1 and 2. The derived emphasis server 240 may be in communication with database 230, which corresponds with remote server 104 or remote database 130 of FIG. 1, may store data relating to conversational inputs, virtual environments, elements within virtual environments, emphasis representations, and emphasis effects. The derived emphasis server 240 may receive conversational input via an input device 311 associated with the UI device set 123 of FIG. 1. Conversational input may be multi-modal conversational input, such as a combination of voice and text, or voice input from a plurality of users participating with the virtual environment 310. The input device 311 may be a microphone, camera, keyboard, or similar input device as part of the EUD 103. The input device 311 may receive at least one of a text input and a voice input. The EUD 103 may include a display 302 which displays a virtual environment 310 including a number of objects 308. The number of objects 308 include digital components within a simulated environment. Objects may include three-dimensional or two-dimensional models, assets, avatars, items, user interface elements or components, etc.

In embodiments of FIG. 3, the derived emphasis server 240 may analyze, via the natural language processing module 214, conversational input between a plurality of users accessing the derived emphasis server 240 via respective EUDs 103. The natural language processing module 214 may employ NLP of the conversational input. In particular, the natural language processing module 214 may employ NLP techniques of the conversation input, which include: tokenization of individual words, phrases, or characters to analyze them individually; semantic analysis including semantic labeling and semantic similarity analysis to understand the meaning of words and phrases in context; analyzing grammatical structure of words and phrases; sentiment analysis to identify tone; topic modeling; or text classification based on word or phrase content. Further, the natural language processing module 214 may utilize NLP techniques, such as latent semantic analysis (LSA) and latent Dirichlet allocation (LDA) to infer relationships between words and phrases or infer meaning behind words or phrases, such as by semantic labeling and semantic similarity analysis. In this way, the natural language processing module 214 may utilize NLP to infer a description of an element within the conversational input. In this manner, embodiments may be configured to, via the natural language processing module 214, analyze a conversational input between a plurality of users to identify a description of an element within a virtual environment or identify a description of an element within the conversational input. Further, embodiments may be configured to identify the description of an element 304 (as shown in FIG. 3) within the conversational input. In further aspects of the present invention, the identifying the description of the element 304 includes inferring the description via NLP of the conversational input.

The derived emphasis server 240 may apply a matching procedure between the conversational input and the virtual environment 310 to identify the element 304 within the virtual environment 310 by matching the description of the element within the conversational input via the machine learning model module 210 of FIG. 2 via generative AI. For example, based on the analysis of the conversational input, the conversational input may include a reference to a “tree,” among other terms or phrases identified within the conversational input. As part of the matching procedure, the derived emphasis server 240 may identify objects 308 within the virtual environment 310 using screen scraping or image processing of elements shown within the virtual environment 310. Image processing may include image processing of rendered elements, such as those shown on a display. Image processing may also be integrated with source files of a program rendering the elements to be displayed. The derived emphasis server 240 may compare the “tree” conversational input to objects 308, including the element 304, within the virtual environment to identify objects 308 matching the “tree” conversational input. In this example, the derived emphasis server 240 may match objects 308 in the conversational input with the identified element 304. In this manner, embodiments may be configured to identify the element 304 within the virtual environment 310 based on the description of the element 304 within the conversational input.

With regards to FIG. 3, the derived emphasis server 240 may generate an emphasis representation in a programmatic model of the virtual environment 310 based on identification of the element 304 and the matching procedure. The machine learning model module 210 may be trained using NLP processed conversational input and identified elements 304 and objects 308 within a virtual environment to identify patterns within the conversational input, the elements 304, and the objects 308, to generate the emphasis representation within a programmatic model that corresponds to the virtual environment 310. The emphasis representation may be a software-implemented technique to identify, group, or otherwise record specific data elements as critical information. The emphasis representation may include prioritizing certain elements 304 within the programmatic model by assigning higher weights or scores to the element 304, or employing algorithms that provide preference to certain data, such as an asset or model which relate to the element 304. The emphasis representation may also include grouping or addressing objects 308 as groups, including subparts. The derived emphasis server 240 may also use a matching procedure to identify element 304 as relevant to the conversational input. Further, the derived emphasis server 240 may generate an emphasis representation specific to element 304 in a programmatic model of the virtual environment 310. In embodiments, the emphasis representation may be derived from virtual environments files within a database, such as by reading object 308 data directly from a corresponding source file and including tagging objects and assets within the database with identifiers. In this way, emphasis representations may be generated by identifying elements 304 within the objects and assets within a database, within program files, or within rendered objects and assets. Emphasis representation may also include grouping objects and assets. The derived emphasis server 240 may utilize the emphasis representation to prioritize applying the emphasis effect 306 to element 304 instead of applying the emphasis effect 306 to objects 308. For example, using the machine learning model module 210, the emphasis representation may involve applying a weightage to element 304 within the virtual environment 310 identified as relevant to the conversational input received by the input device 311 and as determined by the matching procedure. In this manner, embodiments are configured to generate an emphasis representation in the programmatic model of the virtual environment 310 based on the description of the element 304.

The derived emphasis server 240 may determine a level of confidence indicative of a comparison of the conversational input to element 304 based on the matching procedure and the emphasis representation. In particular, determining the level of confidence may include measuring the similarity or dissimilarity between the conversational input and the element 304. For example, determining the level of confidence identifies similar attributes, properties, or patterns based on feature extraction of the conversational input and the element 304. Additionally, a level of confidence may be determined which indicates that the emphasis representation includes the element 304 by performing feature extraction on element 304 and the emphasis representation and comparing extracted features to one another to determine similarity and a high level of confidence. In embodiments, the level of confidence may be displayed on display 302 as a confidence score which ranges from, e.g., 0-100. The level of confidence may be displayed on or communicated through EUD 103 that is distinct from the emphasis effect 306. For example, the level of confidence may be displayed as a confidence score including a numerical value of 95 rendered on the display 302 of the EUD 103, indicating a high level of confidence that the element 304 with the applied emphasis effect 306 is the object 308 referred to in the conversational input. In another example, the level of confidence may be a numerical score shown via display 302 and the emphasis effect may be a yellow highlight effect which surrounds the element 304. In this manner, embodiments may be configured to include a level of confidence that the emphasis representation includes the element 304.

In aspects of the present invention with regards to FIG. 3, the derived emphasis server 240 may apply an emphasis effect 306 to the element 304 within the virtual environment 310 via the emphasis effect module 212 based on the generated emphasis representation. For example, applying the emphasis effect 306 includes rendering the emphasis effect 306 as part of an overlay program, or instructing a program running the virtual environment 310 to render the emphasis effect 306. The emphasis effect module 212 applies the emphasis effect 306 by using visual or audible effects 307 such as visual highlighting the element 304, visual pointing out the element 304, and outputting audible effects 307 via output device 312. The output device 312 may be a speaker. In embodiments, audible effects 307 may include text-to-speech audio conversion, such that the term “tree” identified in the conversational input may be audibly read back via the output device 312. In this manner, embodiments are configured to apply an emphasis effect 306 to element 304 within the virtual environment 310. In embodiments, the emphasis effect 306 may be applied for a duration of time, such as three to five seconds. The emphasis effect 306 may be adjusted based on the amount of time that has elapsed since the element 304 was identified or when the emphasis effect 306 was applied. For example, the emphasis effect 306 may be adjusted by removing the emphasis effect 306 after sixty seconds from the time the emphasis effect 306 was originally applied. In other embodiments, the emphasis effect 306 may be adjusted by intensifying the emphasis effect 306 over time. For example, the element 304 may be a tree that may receive a yellow highlighting effect that may be applied as part of the emphasis effect 306. The emphasis effect 306 may also change in brightness, hue, intensity, etc., as time passes.

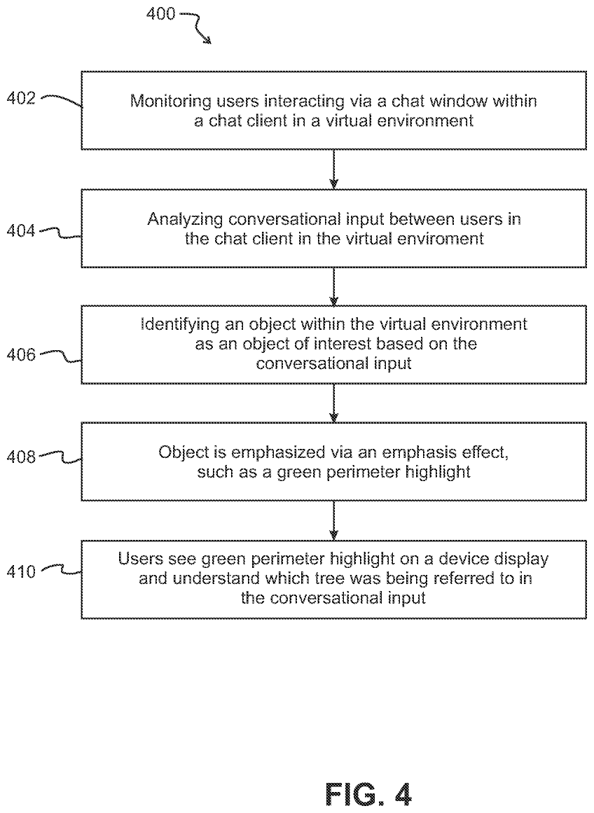

FIG. 4 shows a flowchart 400 of an exemplary use case in accordance with aspects of the present invention. In embodiments, at step 402, the system may monitor, via the natural language processing module 214 of FIG. 2, users interacting via a chat window within a chat client in a virtual environment access via each of the user's respective EUDs 103, corresponding to EUDs 103 of FIGS. 1, 2, and 3. The two users may be participating in a video game program, corresponding to the virtual environment 310 of FIG. 3, and communicating to one another via the chat program, such as via the input device 311 of FIG. 3. In embodiments, the chat program may be a feature of the video game itself. In step 404, the system may analyze, via the natural language processing module 214 of FIG. 2, the conversational input between users in the chat client in the virtual environment. For example, a first user may communicate written text drawing attention to a virtual tree in the virtual environment. In step 406, the system may identify, via the machine learning model module 210 of FIG. 2, an object within the virtual environment as an object of interest based on the conversational input. This may occur by apply the matching procedure, including identifying objects within the video game program via screen scraping or image processing of elements shown within the video game program, or via processing of assets and data within the video game program files and databases. The matching procedure may include correlating the analyzed written text to the objects within the video game program based on similarity. The system may apply the matching procedure to identify the tree referenced by a user as an object of interest based on the user's written text. The system may generate an emphasis representation of the tree identified via the matching procedure. In step 408, the object is emphasized via an emphasis effect via the emphasis effect module 212 of FIG. 2, such as a green perimeter highlight. In this way, in step 410, users may see the green perimeter highlight on a device display corresponding to display 302 of FIG. 3 and understand which tree is being referred to in the conversational input.

In some embodiments, the emphasis effect may not be in a user's rendered line-of-sight. For example, user A and user B may share similar, but not identical views (i.e., identically rendered line-of-sight) of the video game based on the game itself, their respective locations within the game, their progress within the game, etc. In such a case, the emphasis effect may not highlight the identified element itself on user B's EUD, but instead provide an emphasis effect indicating that user B should direct their in-game avatar, character, or attention to look towards the element. This may include providing directional arrows, highlights, on-screen instructions, etc., as the emphasis effect. In embodiments, the emphasis effect may be audible, such as audible effect 307, indicating which element user A is trying to draw user B's attention to.

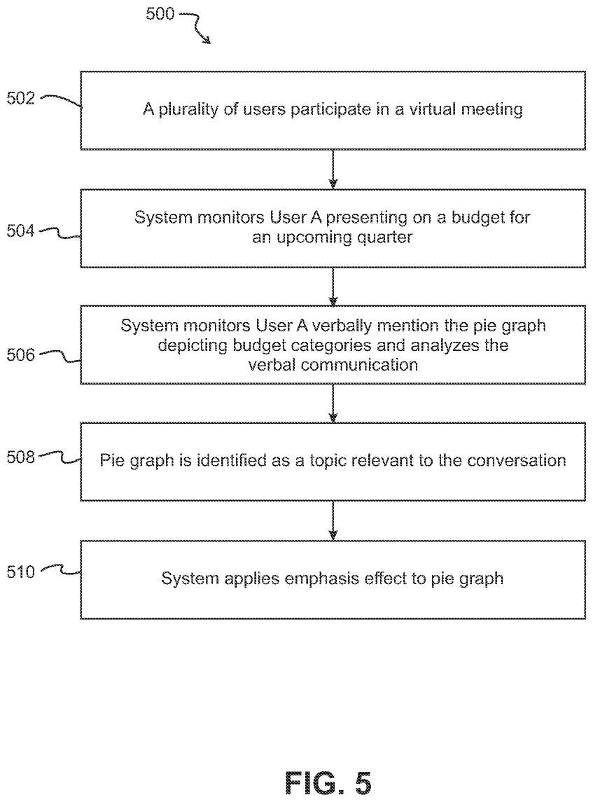

FIG. 5 shows a flowchart 500 of an exemplary use case in accordance with aspects of the present invention. In embodiments, at step 502, a plurality users may be participating in a virtual meeting with one another via a video, audio, and chat program on each of the user's respective EUDs, corresponding to EUDs 103 of FIGS. 1, 2, and 3. For example, the users may be cooperatively working on a budget project through videoconferencing software. The users may be participating and communicating with one another via the videoconferencing software on their respective EUDs. In step 504, the system monitors a first user, user A presenting on a budget for an upcoming quarter via the natural language processing module 214. This may include making a presentation on the budget project, including providing visuals such as histograms, pie charts, etc. In step 506, the system monitors user A verbally mentioning the pie graph depicting budget categories and analyzing the verbal communication via the natural language processing module 214. The system may analyze verbal communication, including performing NLP of the verbal communication or by converting the verbal communication to written text and performing NLP on the written text, to identify words, phrases, etc. In step 508, the pie graph is identified as a topic relevant to the conversation. This may include applying the matching procedure, via the machine learning model module 210, to identify objects within the videoconferencing software via screen scraping or image processing of elements shown within the videoconferencing software, or via processing of assets and data within the videoconferencing software files and databases. For example, the matching procedure may process text and image data within a slideshow file being viewed in the videoconferencing software. The matching procedure may include correlating the analyzed written text to the objects within the videoconferencing software based on similarity. The system may apply the matching procedure to identify the pie graph referenced by user A as an object of interest based on user A's verbal communication. The system may generate an emphasis representation of the pie graph identified via the matching procedure. In step 510, the system applies an emphasis effect to the pie graph, via the emphasis effect module 212, such as highlighting the pie graph with a red outline viewable to all other users participating via the videoconferencing software. In this way, the pie graph is emphasized on screens for all users on the screens of their respective EUDs, corresponding to display 302 of FIG. 3, and understand which pie graph a user was referring to.

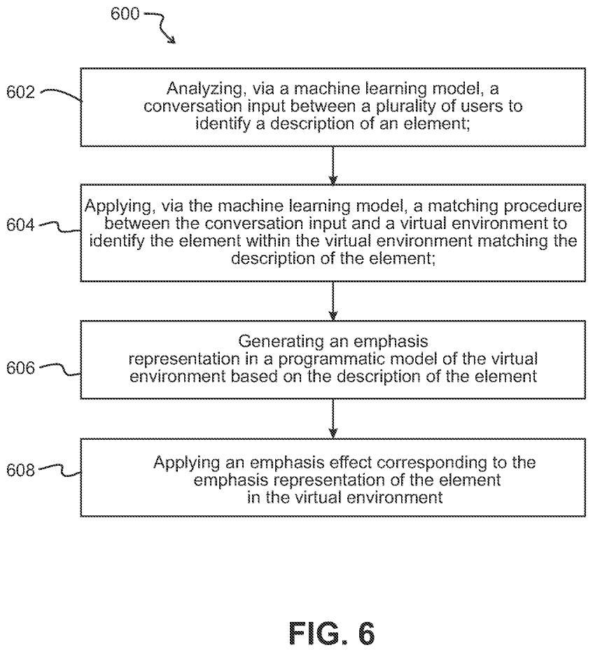

FIG. 6 shows a flowchart 600 of an exemplary method in accordance with aspects of the present invention. In step 602, the system may analyze, via the machine learning model module 210 of FIG. 2, a conversational input between a plurality of users to identify a description of an element. In step 604, the system may apply, via the machine learning model module 210 of FIG. 2, a matching procedure between the conversational input and a virtual environment to identify the element within the virtual environment matching the description of the element. In step 606, the system may generate, via the emphasis effect module 212 of FIG. 2, an emphasis representation in a programmatic model of the virtual environment based on the description of the element. In step 608, the system may apply, via the emphasis effect module 212 of FIG. 2, an emphasis effect corresponding to the emphasis representations of the element within the virtual environment.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can include one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
analyzing, by a processor set and via natural language processing, a conversational input between a plurality of users to identify a description of an element;
applying, by the processor set and via a machine learning model, a matching procedure between the conversational input and a virtual environment to identify the element matching the description of the element;
generating, by the processor set, an emphasis representation in a programmatic model of the virtual environment based on the description of the element; and
applying, by the processor set, an emphasis effect to the element within the virtual environment corresponding to the emphasis representation.

2. The computer-implemented method of claim 1, wherein the applying the emphasis effect comprises rendering the emphasis effect corresponding to the emphasis representation of the element within the virtual environment.

3. The computer-implemented method of claim 1, wherein the applying the matching procedure comprises:
identifying, by the processor set and via the natural language processing, the description of the element within the conversational input; and
identifying, by the processor set, the element within the virtual environment based on the description of the element within the conversational input.

4. The computer-implemented method of claim 3, wherein the identifying the description of the element within the conversational input comprises inferring the description of the element within the conversational input by utilizing semantic similarity analysis.

5. The computer-implemented method of claim 1, further comprising adjusting the emphasis effect applied to the element based on an amount of time that has elapsed since the element was identified.

6. The computer-implemented method of claim 5, further comprising:
determining a level of confidence that the emphasis representation includes the element; and
displaying a confidence score on a display which corresponds with the level of confidence.

7. The computer-implemented method of claim 6, wherein the level of confidence is distinct from the emphasis effect.

8. The computer-implemented method of claim 1, wherein the conversational input comprises a voice input, and wherein the virtual environment is an immersive virtual environment comprising a virtual world environment.

9. The computer-implemented method of claim 1, wherein the conversational input comprises multi-modal conversational input.

10. The computer-implemented method of claim 1, wherein the machine learning model comprises generative artificial intelligence for performing the matching procedure between the conversational input and the virtual environment to identify the element matching the description of the element.

11. A computer program product comprising one or more computer readable storage media having program instructions collectively stored on the one or more computer readable storage media, the program instructions executable to:
analyze, via natural language processing, a conversational input between a plurality of users to identify a description of an element;
apply, via a machine learning model, a matching procedure between the conversational input and a virtual environment to identify the element matching the description of the element;
generate an emphasis representation in a programmatic model of the virtual environment based on the description of the element; and
apply an emphasis effect to the element within the virtual environment corresponding to the emphasis representation.

12. The computer program product of claim 11, wherein the applying the emphasis effect comprises rendering the emphasis effect corresponding to the emphasis representation of the element within the virtual environment.

13. The computer program product of claim 11, wherein the applying the matching procedure comprises:
identifying, via the natural language processing, a description of the element within the conversational input; and
identifying the element within the virtual environment based on the description of the element within the conversational input.

14. The computer program product of claim 13, wherein the identifying the description of the element within the conversational input comprises inferring the description within the conversational input by utilizing semantic similarity analysis.

15. The computer program product of claim 11, wherein the program instructions are executable to: adjust the emphasis effect applied to the element based on an amount of time that has elapsed since the element was identified.

16. The computer program product of claim 15, wherein the program instructions are executable to:
determining a level of confidence that the emphasis representation comprises the element; and
display a confidence score on a display corresponding with the level of confidence.

17. The computer program product of claim 16, wherein the level of confidence is distinct from the emphasis effect.

18. The computer program product of claim 11, wherein the conversational input comprises a voice input, and wherein the virtual environment is an immersive virtual environment comprising a virtual world environment.

19. The computer program product of claim 11, wherein the conversational input comprises multi-modal conversational input.

20. A system comprising:
a processor set, one or more computer readable storage media, and program instructions collectively stored on the one or more computer readable storage media, the program instructions executable to:
analyze, via natural language processing, a conversational input between a plurality of users to identify a description of an element;
apply, via a machine learning model, a matching procedure comprising generative artificial intelligence for performing the matching procedure between the conversational input and a virtual environment to identify the element matching the description of the element;
generate an emphasis representation in a programmatic model of the virtual environment based on the description of the element; and
apply an emphasis effect to the element within the virtual environment corresponding to the emphasis representation.
